(19) United States
(12) Patent Application Publication
(10) Pub. No.: US 2015/0124456 A1
(43) Pub. Date: May 7, 2015

(54) LIGHT EMITTING ARRANGEMENT

(71) Applicant: KONINKLIJKE PHILIPS N.V., EINDHOVEN (NL)

(72) Inventors: Rifat Ata Mustafa Hikmet, Eindhoven (NL); Ties Van Bommel, Horst (NL)

(21) Appl. No.: 14/399,779

(22) PCT Filed: May 8, 2013
(86) PCT No.: PCT/IB13/53690

§ 371 Date: Nov. 7, 2014

Related U.S. Application Data
(60) Provisional application No. 61/644,571, filed on May 9, 2012.

(51) Int. Cl. F21V 13/08; F21K 99/00

(52) U.S. Cl. CPC F21V 13/08; F21K 9/56; F21K 9/54
USPC 362/293

(57) ABSTRACT

A light emitting arrangement (100) is provided, comprising: -a solid state light source (101, 201) adapted to emit primary light; and -a wavelength converting member (105, 205) arranged to receive said primary light and capable of converting said primary light into secondary light, the wavelength converting member and the solid state light source being mutually spaced apart; and a non-absorbing, partially transparent reflector (106, 206) arranged on a light output side of the wavelength converting member. The reflector hides the color of the phosphor and may give the arrangement a silver or golden metallic appearance, which is more desirable for many applications. By using a non-absorbing reflector, efficiency is high and also less phosphor is required, which further contributes to the improved visual appearance.

### FIELD OF THE INVENTION

The present invention relates to light emitting arrangements comprising a solid state light source and a wavelength converting element, and to lamps and luminaires comprising such light emitting arrangements.

### BACKGROUND OF THE INVENTION

Light-emitting diode (LED) based illumination devices are increasingly used for a wide variety of lighting and signaling applications. LEDs offer advantages over traditional light sources, such as incandescent and fluorescent lamps, including long lifetime, high lumen efficacy, low operating voltage and fast modulation of lumen output. Efficient high-power LEDs are often based on blue light emitting InGaN materials. To produce an LED based illumination device, or another solid state illumination device, having a desired color (e.g. white) output, a suitable wavelength converting material, commonly known as a phosphor, may be provided which converts part of the light emitted by the LED into light of longer wavelengths so as to generate a combination of light having the desired spectral characteristics. An example of a suitable wavelength converting material for use in a blue LED based device for emitting white light is a cerium-doped yttrium aluminum garnet (YAG:Ce).

A disadvantage of the LED-phosphor based illumination devices is that in the off state, the color of the phosphor may be clearly visible. For example, YAG:Ce has a distinct yellowish or orange appearance. Such an appearance may be undesired for aesthetic reasons, and might not appeal to customers. Therefore, techniques have been developed to produce solid state illumination devices having a neutral, e.g. white or whitish, appearance in the off-state. One such technique is disclosed in US 2005/0201109, which describes a lighting apparatus comprising a light source, a lens disposed to face the emission surface of the light source, and a half-mirror film provided on at least a surface of the lens. The half-mirror film is a thin film comprising a metallic material and provides a light shielding mechanism through which the inside or structure of the lighting apparatus cannot be seen from the outside when the apparatus is in the off state. However, the apparatus suffers from low efficiency, and is bulky due to the presence of the lens. Hence, there is a need in the art for improved light emitting devices, which in the functional off-state have a neutral appearance.

### SUMMARY OF THE INVENTION

It is an object of the present invention to overcome this problem, and to provide improved light emitting devices which have a desirable off-state appearance.

According to a first aspect of the invention, this and other objects are achieved by a light emitting arrangement comprising:
a solid state light source adapted to emit primary light; and
a wavelength converting member arranged to receive said primary light and capable of converting said primary light into secondary light, the wavelength converting member and the solid state light source being mutually spaced apart; and
a non-absorbing, partially transparent reflector arranged on a light output side of the wavelength converting member.

The reflector hides the color of the wavelength converting member and may give the arrangement a silver or golden metallic appearance, which is more desirable for many applications. By using a non-absorbing reflector, efficiency is high and also less phosphor is required, which further contributes to the improved visual appearance (color of phosphor is less visible). Advantages of using a remote or vicinity configuration, compared to arrangements where the wavelength converting member is in direct contact with the light source, include reduced phosphor degradation due to overheating and thus increased phosphor lifetime, as well as improved color stability over time. The remote configuration may also provide a light emitting surface which in particular in combination with a light mixing chamber as described below, allow a compact design without the need for collimating lenses etc.

In embodiments of the invention, the non-absorbing, partially transparent reflector has uniform reflectivity of light over the wavelength range of from 400 nm to 800 nm.

Typically, non-absorbing means an absorption of less than 1%. Hence, in embodiments of the invention the non-absorbing, partially transparent reflector has an absorption of incident light of less than 1%. The non-absorbing, partially transparent reflector is typically non-metallic, as metallic reflectors tend to have undesirably high absorption of light.

For example, the non-absorbing, partially transparent reflector comprises at least one non-absorbing layer comprising a material, typically a dielectric material, selected from glass and plastic material. Said plastic material may be selected from polycarbonate (PC), poly methyl methacrylate (PMMA), polyethylene terephthalate (PET), and polyethylene naphthtalate (PEN).

In embodiments of the invention the non-absorbing, partially transparent reflector comprises a stack of non-absorbing layers. Typically, each layer of said stack of non-absorbing layers may have a uniform reflectivity over the wavelength range of from 400 nm to 800 nm.

In some embodiments, the non-absorbing, partially transparent reflector may be a specular reflector.

In embodiments of the invention, the non-absorbing, partially transparent reflector has a reflectivity in the range of from 20% to 60%, preferably from 30% to 45%, and more preferably from 35%, or from higher than 35%, to 45%.

In some embodiments, the light emitting arrangement comprises a light mixing chamber defined by a reflective bottom portion and at least one reflective side wall. The solid state light source may be arranged on the bottom portion or on the side wall. The light mixing chamber provides high efficiency, good mixing of light in the on state and in combination with a remote phosphor allows a compact design without the need for collimating lenses etc.

In some embodiments, the non-absorbing, partially transparent reflector forms a light exit window through which light may exit the light mixing chamber.

The wavelength converting member may be arranged on a surface of the non-absorbing, partially transparent reflector facing towards the solid state light source. Alternatively or additionally the wavelength converting member may be arranged on said reflective bottom portion and said solid state light source is arranged on said reflective side wall.

In another aspect, the invention provides a lamp, for example a retrofit lamp, comprising a light emitting arrangement as described herein.

In a further aspect, the invention also provides a luminaire comprising at least one light emitting arrangement as described herein.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 is a cross-sectional side view of a light emitting arrangement according to embodiments of the invention.

FIG. 2 is a cross-sectional side view of a light emitting arrangement according to embodiments of the invention and schematically illustrates a viewer looking at the light emitting arrangement in the off state.

FIG. 3 is a cross-sectional side view of a light emitting arrangement according to another embodiment of the invention.

FIG. 4 is a cross-sectional side view of a light emitting arrangement according to another embodiment of the invention.

FIG. 5 is a cross-sectional side view of a light emitting arrangement according to another embodiment of the invention.

FIG. 6 is a side view, partially in cross-section, of a lamp according to embodiments of the invention.

FIG. 7 is a perspective view of a luminaire according to embodiments of the invention.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

The present inventors have found that a semi-transparent reflector can advantageously be used for hiding the natural color of a phosphor and instead giving a more desirable, metallic appearance to a phosphor-containing light emitting arrangement.

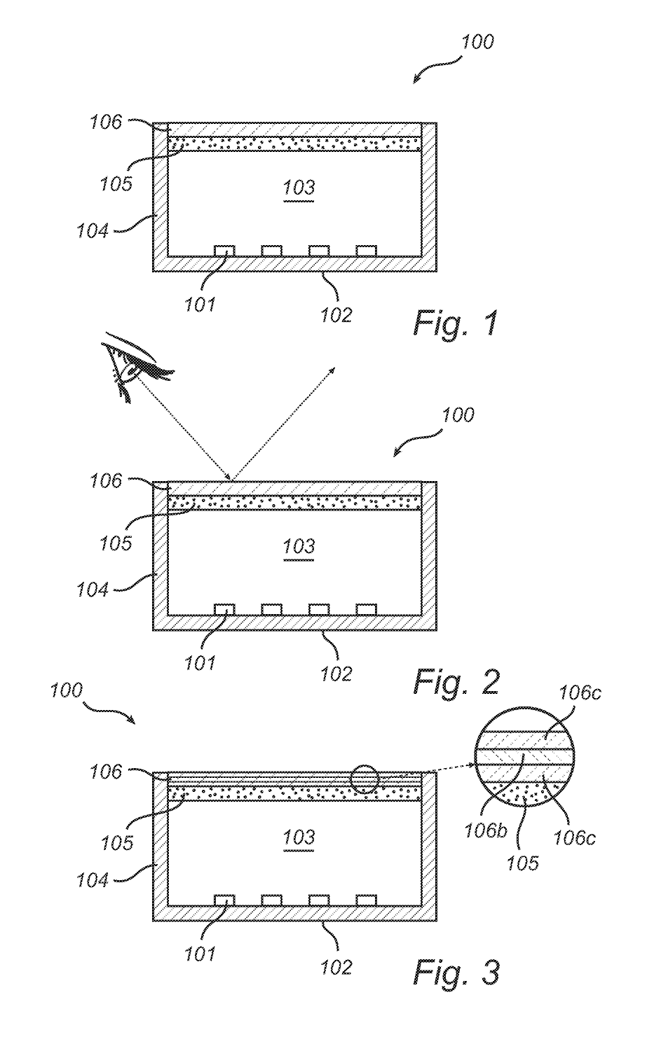

A light emitting arrangement according to an embodiment of the invention is depicted in FIG. 1. The light emitting arrangement 100 comprises a plurality of light sources 101, here LEDs, arranged on a bottom portion 102 of a light mixing chamber 103. The light mixing chamber 103 is surrounded by a circular side wall 104. A wavelength converting member 105, is arranged spaced apart from the light sources 101, so-called remote phosphor mode. On the other side of the wavelength converting member 105 a partially reflective, partially transparent member 106 is provided, as seen in the light output direction from the light source and the wavelength converting member. The partially reflective, partially transparent member is hereinafter referred to as a partially transparent reflector. The partially transparent reflector may have low or substantially no absorption. “No absorption”, or “non-absorbing”, here means that the reflector or layer in question has an aborption of 1% or less than 1% of incident light, preferably over the whole visible wavelength range. The partially transparent reflector may be a plate, a sheet, a film or a foil, formed of a single layer or a stack of multiple layers. In the case of a stack of multiple layers, the layers may be the same or different with respect to material composition and optical (e.g. reflection and/or transmission) properties.

In operation, primary light emitted by the light sources 101 is received by the wavelength converting element, possibly after being reflected by the side wall and/or the bottom portion, both of which may be reflective. The wavelength converting member converts at least part of the primary light into secondary light of a longer wavelength. The converted, secondary light is partly emitted in the light output direction (towards a viewer 107) and partly emitted back into the light mixing chamber, where it may be reflected and redirected in the light output direction. Secondary light and any unconverted primary light is transmitted by the partially transparent reflector 106 and thus exits the light emitting arrangement. Preferably, side wall and optionally also the bottom portion of the light mixing chamber is highly reflective, thus ensuring good mixing of light, good light distribution and high efficiency due to light recycling and minimized absorption.

It is envisaged that the side wall and hence the reflective chamber may have any suitable geometrical shape. For example, instead of a circular side wall, the light emitting arrangement may comprise one or more side walls defining e.g. a square, rectangular or other polygonal chamber.

The partially transparent reflector 106 serves primarily to prevent the color of the wavelength converting member from being visible from the outside when the light emitting arrangement is in the off state, i.e. not in operation. In the off state, as illustrated in FIG. 2, light incident on the light emitting arrangement from the outside is partially reflected and partially transmitted. Due to this reflection of light, the color of the wavelength converting element is less visible from the outside and instead the light emitting arrangement may be given a metallic, for example silver or golden, appearance by adapting the thickness and/or the refractive index of the reflector.

The partially transparent reflector 106 typically has uniform reflectivity over the entire visible spectrum, so that it reflects all wavelengths of light to the same extent. Typically, the partially transparent reflector has a reflectivity of 20-60%, such as 30-45% or 35-45%. In some embodiments, the reflectivity is higher than 35% and may be up to, for example, 45%.

In some embodiments, the partially transparent reflector is a specular reflector.

FIG. 3 illustrates an embodiment of the light emitting arrangement in which the partially transparent reflector 106 comprises a stack of multiple, non-absorbing layers 106a, 106b, 106c. Such a layer stack may comprise at least two layers, for example three layers. In one example, the partially transparent reflector 106 may be a stack of two glass plates. In another example, the partially transparent reflector 106 may be a stack of three plastic plates. In yet another example, the partially transparent reflector 106 may comprise a stack of multiple plastic foils.

The partially transparent reflector may be formed of any suitable non-absorbing, sufficiently transmissive and reflective material(s). Typically, dielectric materials may be used for the layers 106a, 106b, 106c. Examples of suitable dielectric materials include:
titanates such as barium titanate, barium strontium titanate, strontium titanate, magnesium titanate, calcium titanate, bismuth titanate, neodymium titanate, magnesium calcium silicon titanate, and lead titanate;
zirconates such as calcium zirconate, barium zirconate and zirconium oxide;
oxide materials such as titanium dioxide, tin oxide, calcium stannate, bismuth trioxide, and magnesium zinc niobate magnesium fluoride, silicon dioxide, tantalum pentoxide, and zinc sulfide.

A multilayer reflector as illustrated in FIG. 3 can be designed to have any desirable appearance, e.g. a neutral or silver appearance, or a golden appearance, by adjusting the thickness and the refractive indices of the layers 106a, 106b, 106c.

Other examples of suitable materials for the partially transparent reflector as a whole or for one or more layers thereof include glass and plastic materials, such as polycarbonate (PC), poly methyl methacrylate (PMMA), polyethylene terephthalate (PET), and polyethylene naphthalate (PEN).

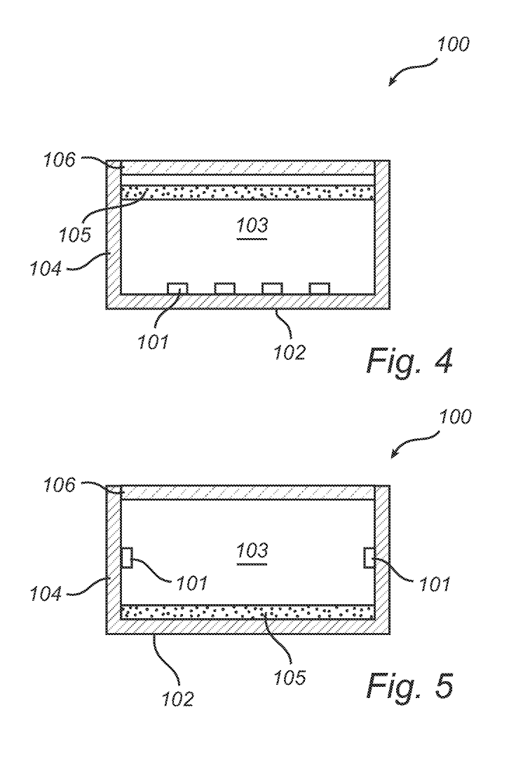

FIG. 4 illustrates another embodiment of the light emitting arrangement in which the wavelength converting member 105 and the partially transparent reflector 106 are mutually spaced apart. The wavelength converting member is still also spaced apart from light sources 101, separated e.g. by an air gap. In some embodiments, the distance between the light sources and the wavelength converting member may be relatively small, so-called vicinity phosphor mode. However, in such embodiments the wavelength converting member still does not contact the light sources. In such vicinity phosphor mode embodiments, the wavelength converting member may be arranged at a distance from the partially transparent reflector as shown in FIG. 3, or may be arranged in contact with the partially transparent reflector, similar to the embodiment shown in FIGS. 1 and 2. The vicinity phosphor mode thus allows a compact design of the light emitting arrangement.

The light sources may be located at any suitable position in the light mixing chamber, for example symmetrically on a central portion of the bottom portion 102. Although the drawings show light-emitting arrangement using a plurality of light sources, it is contemplated the a single solid state light source could also be used, such as a single LED or a single laser diode. Where a single light source is used, it is typically arranged centrally on the bottom portion 102.

FIG. 5 shows an alternative embodiment of a light emitting arrangement 100 in which two light sources 101 are mounted on the inner surface of the side wall 104. A plurality of light sources may for example be mounted at regular distances from each other all along the circumference of the side wall. In the case of two light sources, the light sources are typically mounted opposite each other. FIG. 5 further shows the wavelength converting member 105 being arranged at a bottom portion 102 of the light mixing chamber 103. In this embodiment, the bottom portion is preferably reflective, such that all light emitted (converted) or transmitted by the wavelength converting member is directed towards the light exit window formed by the partially transparent reflector 106. Such a light emitting arrangement may be referred to as “reflective mode” with respect to a phosphor or wavelength converting member.

As mentioned above, the solid state light source may be a light emitting diode (LED) or a laser diode. Alternatively the light source may be an organic light emitting diode (OLED). In some embodiments the solid state light source may be a blue light emitting LED, such as GaN or InGaN based LED, for example emitting primary light of the wavelength range from 440 to 460 nm. Alternatively, the solid state light source may emit UV or violet light which is subsequently converted into light of longer wavelength(s) by one or more wavelength converting materials.

The secondary light is typically of a longer wavelength than the primary light. For example, the secondary light may be of the wavelength range of 400 nm to 800 nm, for example 500 nm to 800 nm, such as from 570 to 620 nm. Combining primary blue light with a a wavelength converting member that is capable of converting blue light into yellow light, a total white light output may be obtained. Hence, the wavelength converting material(s) of the wavelength converting member is typically selected with regard to the light source used and the desired spectral composition of the output light.

The wavelength converting material used in the present invention may be an inorganic wavelength converting material or an organic wavelength converting material. Examples of inorganic wavelength converting materials may include, but are not limited to, cerium (Ce) doped yttrium aluminum garnet (Y₃Al₅O₁₂:Ce³⁺, also referred to as YAG:Ce or Ce doped YAG) or lutetium aluminum garnet (LuAG, Lu₃Al₅O₁₂), a-SiAlON:Eu²⁺ (yellow), and M₂Si₅N₈:Eu²⁺ (red) wherein M is at least one element selected from calcium Ca, Sr and Ba. Furthermore, a part of the aluminum of YAG:Ce may be substituted with gadolinium (Gd) or gallium (Ga), wherein more Gd results in a red shift of the yellow emission. Other suitable materials may include (Sr_{1-x-y}BaₓCa_{y})_{2-z}Si₅₋ₐAlₐN₈₋ₐOₐ:Eu_{z}²⁺ wherein 0≦a<5, 0≦x<1, 0≦y≦1 and 0≦z≦1, and (x+y)≦1, such as Sr₂Si₅N₈:Eu²⁺ which emits light in the red range. Examples of suitable organic wavelength converting materials are organic luminescent materials based on perylene derivatives, for example compounds sold under the name Lumogen® by BASF. Examples of suitable compounds that are commercially available include, but are not limited to, Lumogen® Red F305, Lumogen® Orange F240, Lumogen® Yellow F083, and Lumogen® F170, and combinations thereof. Advantageously, an organic luminescent material may be transparent and non-scattering.

Furthermore, in some embodiments, the wavelength converting material may be quantum dots or quantum rods. Quantum dots are small crystals of semiconducting material generally having a width or diameter of only a few nanometers. When excited by incident light, a quantum dot emits light of a color determined by the size and material of the crystal. Light of a particular color can therefore be produced by adapting the size of the dots. Most known quantum dots with emission in the visible range are based on cadmium selenide (CdSe) with shell such as cadmium sulfide (CdS) and zinc sulfide (ZnS). Cadmium free quantum dots such as indium phosphide (InP), and copper indium sulfide (CuInS₂) and/or silver indium sulfide (AgInS₂) can also be used. Quantum dots show very narrow emission band and thus they show saturated colors. Furthermore the emission color can easily be tuned by adapting the size of the quantum dots. Any type of quantum dot known in the art may be used in the present invention. However, it may be preferred for reasons of environmental safety and concern to use cadmium-free quantum dots or at least quantum dots having a very low cadmium content.

Optionally the wavelength converting member may comprise scattering elements. Examples of scattering elements include pores and scattering particles, such as particles of TiO₂ or Al₂O₃.The scattering elements may be mixed with a wavelength converting material or provided as a separate layer.

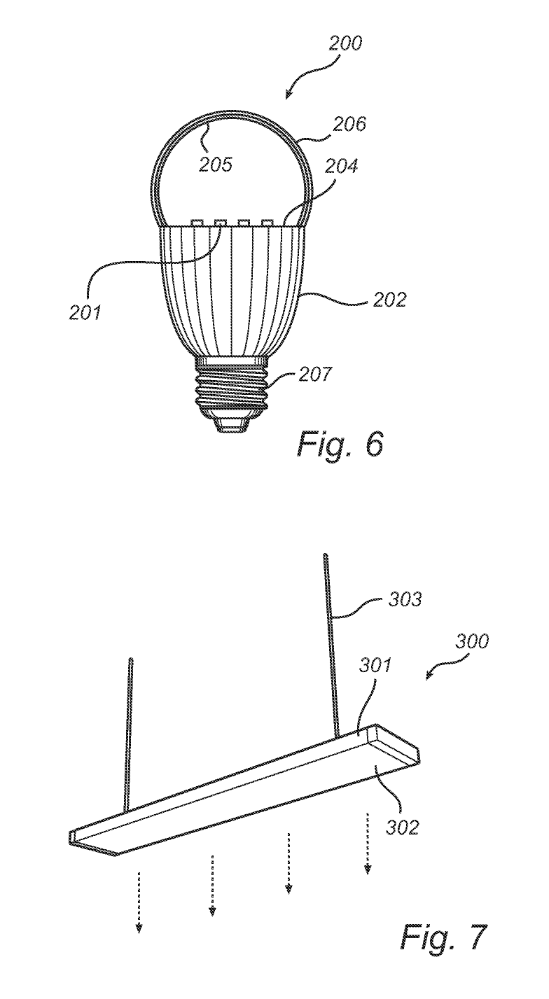

The light emitting arrangement of the invention may be used in any type of lighting application, in particular lamps and luminaires where the light emitting arrangement is visible from the outside, that is, lamps and luminaires in which the color of the wavelength converting member might have been visible if it were not for the partially transparent reflector. An example of a lamp comprising a light emitting arrangement according to embodiments of the invention is illustrated in FIG. 6. The lamp 200 is a so-called retrofit lamp, intended to replace a conventional incandescent light bulb. The lamp 200 comprises a base portion 202 provided with a screw fitting 207 adapted for a screw socket. The base portion 202 has a planar top surface 204 which may be reflective. A plurality of light sources 201 are arranged centrally on the top surface 204. A partially transparent reflector 206 having the shape of a dome or part of a sphere is arranged as a cover over the light sources, preferably covering the entire top surface 204 of the base portion 202. A wavelength converting member 205 is provided in contact with the partially transparent reflector 206, on a surface of the partially transparent reflector facing the light sources 201.

FIG. 7 shows a luminaire 300 comprising at least one light emitting arrangement according to the invention. The luminaire 300 comprises a housing 301 and a light exit window 302. The housing 301 may have a reflective inner surface, and the light exit window may be a partially transparent reflector as described above. Alternatively, the light exit window 302 may be a transparent plate and the luminaire 300 may instead comprise one or more partially transparent reflectors located within the space defined by the housing 301 and the light exit window 302.

Typically the luminaire 300 comprises a plurality of solid state light sources arranged in an array or any other suitable pattern on an interior surface of the housing 301.

The luminaire shown in FIG. 7 is intended to be suspended from e.g. a ceiling and therefore further comprises suspension means 303 attached to a top portion of the housing 301. In some embodiments, part or all of the top portion of the housing may also be transparent, thus allowing light emission in two directions simultaneously. Furthermore, in some embodiments, the luminaire may be mounted on a stand instead of being suspended.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A light emitting arrangement comprising:
a solid state light source adapted to emit primary light; and
a wavelength converting member arranged to receive said primary light and capable of converting said primary light into secondary light, the wavelength converting member and the solid state light source being mutually spaced apart; and
a non-absorbing, partially transparent reflector arranged on a light output side of the wavelength converting member, wherein primary light emitted by the solid state light source and secondary light produced by the wavelength converting member can be transmitted the non-absorbing, partially transparent reflector to exit the light emitting arrangement, and wherein the non-absorbing, partially transparent reflector has uniform reflectivity of light over the wavelength range of from 400 nm to 800 nm.

2. (canceled)

3. The light emitting arrangement according to claim 1, wherein the non-absorbing, partially transparent reflector comprises a stack of non-absorbing layers.

4. The light emitting arrangement according to claims 2, wherein each layer of said stack of non-absorbing layers has a uniform reflectivity over the wavelength range of from 400 nm to 800 nm.

5. The light emitting arrangement according to claim 1, wherein the non-absorbing, partially transparent reflector is non-metallic.

6. The light emitting arrangement according to claim 1, wherein the non-absorbing, partially transparent reflector comprises at least one non-absorbing layer comprising a material selected from dielectric materials, glass and plastic materials.

7. The light emitting arrangement according to claim 6, wherein said plastic material is selected from polycarbonate, poly methyl methacrylate, polyethylene terephthalate, and polyethylene naphthtalate.

8. The light emitting arrangement according to claim 1, wherein the non-absorbing, partially transparent reflector is a specular reflector.

9. The light emitting arrangement according to claim 1, wherein the non-absorbing, partially transparent reflector has a reflectivity in the range of from 20% to 60%.

10. The light emitting arrangement according to claim 1, comprising a light mixing chamber defined by a reflective bottom portion and at least one reflective side wall.

11. The light emitting arrangement according to claim 10, wherein the non-absorbing, partially transparent reflector forms a light exit window through which light may exit the light mixing chamber.

12. The light emitting arrangement according to claim 1, wherein the wavelength converting member is arranged on a surface of the non-absorbing, partially transparent reflector facing towards the solid state light source.

13. The light emitting arrangement according to claim 10, wherein the wavelength converting member is arranged on said reflective bottom portion and said solid state light source is arranged on said reflective side wall.

14. A lamp comprising a light emitting arrangement according to claim 1.

15. A luminaire comprising at least one light emitting arrangement according to claim 1.
